(19) United States
(12) Patent Application Publication
(10) Pub. No.: US 2007/0031649 A1
(43) Pub. Date: Feb. 8, 2007

(54) Timing apparatus for monitoring item out-time

(76) Inventor: Barry J. Bauer, Woodbury, MN (US)

Correspondence Address: BROOKS & CAMERON, PLLC, 1221 NICOLLET MALL #500, MINNEAPOLIS, MN, 55403, US

(21) Appl. No.: 11/196,183

(22) Filed: Aug. 2, 2005

(51) Int. Cl. B32B 5/14

(52) U.S. Cl. 428/308.4

(57) ABSTRACT

One apparatus embodiment includes a timing apparatus for monitoring item out-time. The apparatus includes a timer and a triggering mechanism. The triggering mechanism is provided for changing the state of the timer based upon an environmental condition.

### FIELD OF THE INVENTION

The present disclosure generally relates to environmentally triggered timers. And, in particular, the present disclosure relates to timers for determining the out-time of an item.

### BACKGROUND

There are many contexts and technological fields that involve timing with respect to an item. For example, in some situations, an item having an expiration date, such as a food item, can be monitored to make sure that it should still be offered for sale. For instance, items like bread and milk include sale expiration dates to indicate that the item should be disposed of after the date marked on the item.

In other instances, movement of an item from one environment to another can, over time, cause the item to become unusable. For example, in the area of composite materials, composites are often provided through use of a prepreg material.

Prepreg is a combination of mat, fabric, non-woven, woven, and/or roving material that has been pre-impregnated with a resin. The prepreg is usually prepared to a state where it is ready for curing. The curing process can be accomplished in various manners depending upon the type of resin and/or material used to form the prepreg.

Curing means to set the shape of the resin so that the shape cannot be changed. Curing can be accomplished, for example, by chemical reaction or other such mechanism and can be accomplished with or without a catalyst.

One type of prepreg that is often used is a prepreg utilizing a thermoset resin. Thermoset resins change into substantially infusible and/or insoluble materials when cured, for example, by the application of heat and/or by introduction of a chemical.

Thermoset materials that cure by application of heat are typically refrigerated so that they remain pliable and tacky. Since such thermoset prepreg materials cure when heated, when being exposed to heat over time, the prepreg eventually reaches a point where it is no longer usable. Such a result can even occur through the removal of the prepreg from refrigeration in order for it to be used. Unusable prepreg typically has lost its pliability and/or tackiness.

In order to know when the prepreg becomes unusable, the time that the prepreg is out of the refrigerator (out-time) is usually monitored. However, the methods of monitoring the prepreg are typically rudimentary in nature. For example, one method of monitoring the out-time of prepreg is to write the time the prepreg is removed from the refrigerator and the time it is placed back into the refrigerator on a piece of paper.

In some instances, the elapsed time is then calculated from the recorded time out and time in. Further, in some instances, this elapsed time is then subtracted from an estimate of the time that the prepreg can be out of the refrigerator before becoming unusable. Oftentimes, individuals removing the prepreg will forget to log their out-time, or will estimate the out-time. These instances can result in inaccurate calculating of the out-time.

Additionally, in some cases, there can be several rolls of prepreg in the same refrigerator or storage area. In these cases, there can be different out-time logs for each roll. In these instances, the logs can be confused, among other difficulties.

### SUMMARY

The present disclosure provides a number of embodiments for monitoring item out-time. For example, in one apparatus embodiment, the apparatus includes a timing apparatus for monitoring item out-time having a timer and a triggering mechanism.

The timer can be one of various types of timing mechanisms. For example, timers can count in an ascending (e.g., an incrementing timer) or descending (e.g., a decrementing timer) fashion. And, in some embodiments, timers can be reset or set with a different time than its original setting.

Further, in various embodiments, the timer can include or be associated with a mechanism for recording information about the out-time of an item. Suitable mechanisms can include logic circuitry, such as state logic or a processor and memory, among other types of logic and storage elements. In various embodiments, different power sources or power circuits can be used to power the timer, the memory, and/or the logic.

Logic can be provided, for example, to count from a first predetermined time to a second predetermined time (e.g., from 10 minutes to 2 minutes or from 0 minutes to 10 minutes, etc.). This can be a running count that starts when a triggering event occurs or can be a timer where the elapsed time is calculated and the calculated elapsed time is added or subtracted to a running value representing the total elapsed out-time.

For example, a clock can be used to record the out-time and in-time for the item. This information can be used to identify the elapsed time that the item was out of the refrigerator during a particular job. The elapsed time can then be added, for example, if the timer is an ascending timer, to the total elapsed time that has been accumulated from earlier jobs. In this manner, the timer is not a running counter, but rather, is reduced in increments equal to the calculated elapsed time for each job.

The logic can be used to act on, analyze, and/or record a variety of information. For example, the apparatus can record various types of timing information that can be used by various embodiments of the present disclosure to provide different kinds of indications of the state of a item regarding its usability and/or expiration. The timing information can include, but is not limited to: time out, time in, elapsed time, current remaining time (e.g., ascending or descending), number of times the item has been taken out and/or put in, whether an item has reached or surpassed a time threshold, date that a threshold as been met, and/or date when time expired, among other information.

The time an item is removed from storage and/or the time an item is returned to storage can be measured from when a triggering event occurs or from when the timer changes state (e.g., from off to on or from on to off). An explanation of the different kinds of timing indications that can be used to indicate the state of a item will be discussed in more detail below.

Based upon the timing information, and in some embodiments, other information, the timing apparatus can provide a user with information regarding when the item has expired and/or is no longer usable. Other information types that can be used can include, for example, information about the type of item and its characteristics of reduced use-ability and/or expiration.

In various embodiments, the logic can have a number of time thresholds associated therewith. These thresholds can be used to define a number of diminishing purposes for the item and/or can be used as warnings as expiration approaches, for example. Accordingly, in some embodiments, the apparatus can include a number of types of indicators in various embodiments of the present disclosure. For example, an incrementing or decrementing indicator can be used where a time value changes from a first value to a second value.

The time elapsed between the first value and the second value is indicative of the suggested out-time for the item, or some portion of the out-time (e.g., if a number of thresholds prior to expiration are in place, then the time may be indicative of a period less than the total out-time). Indicators can include numeric, alpha, or alphanumeric readouts; time readouts; text indicators; symbol indicators; colored indicators; or other such indicator types that can be used to identify a change from one state to one or more other states (e.g., usable, expired, and/or unusable).

The apparatus also includes a triggering mechanism for changing the state of a timing component. The triggering mechanism can be triggered by an environmental condition (e.g., moisture, temperature, pressure, etc). For example, in some embodiments, the triggering mechanism can take advantage of the properties of thermal expansion of a temperature sensitive material, such as a metallic strip, to close a circuit (e.g., making an electrical connection to power the timer), thereby changing the state of a timer between an off state and an on state.

Such an embodiment can be useful with prepreg, for example, because the connection of the strip can be calibrated to close the circuit when the prepreg leaves the refrigerator and open the circuit when the prepreg returns to the refrigerator. Additionally, such embodiments, allow the timing apparatus to be attached to the item and, thereby, confusion between timers can be avoided.

Also, since, the trigger mechanism is the same condition that degrades the usefulness of the prepreg (e.g., temperature) the trigger can be set to being counting when the prepreg begins to degrade, making the timing apparatus more accurate and allowing the timing apparatus to be designed to automatically monitor the out-time. In this way, the issue of human error can be reduced or eliminated.

Additionally, some embodiments of the present disclosure can include any of various mechanisms for attaching the timing apparatus to an item. Examples of suitable types of attachment mechanisms include, but are not limited to, mechanical type fasteners such as hook and loop, snaps buttons, ties, etc. and, natural or chemical fasteners, such as glues, epoxies, and bonding compounds, among others. The attachment mechanism can, for example, be positioned on a tab extending from a body portion of the apparatus, be positioned on the back of the apparatus, or on another suitable surface of the timing apparatus and/or a surface of an item.

### BRIEF DESCRIPTION OF THE DRAWINGS

FIG. 1 is an illustration of an embodiment of a timing apparatus for monitoring item out-time.

FIG. 2 is an close up illustration of an embodiment of a timing apparatus for monitoring item out-time.

FIG. 3 is an illustration of an embodiment of a triggering mechanism for use with various timing apparatus embodiments.

### DETAILED DESCRIPTION

The present disclosure includes a number of out-time calculating embodiments. Embodiments of the present disclosure will now be described in relation to the accompanying drawings, which will at least assist in illustrating the various features of the various embodiments.

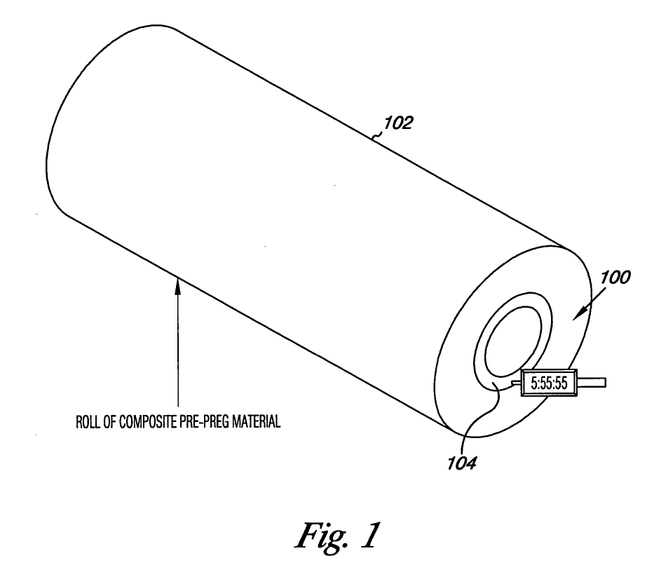

FIG. 1 is an illustration of an embodiment of a timing apparatus for monitoring item out-time. In the illustration of FIG. 1, the item 102 is a roll of prepreg material. As will be known to those of ordinary skill in the art, prepreg material typically is designed as a web of pre-impregnated fabric or other such material that is rolled on a core 104 for ease of use.

When an individual wants to use the prepreg, the roll 102 is removed from a refrigerated area. A portion of the web is then cut from the roll 102 and is used. The roll of prepreg material 102 is then placed back into the refrigerated area until it is to be used again.

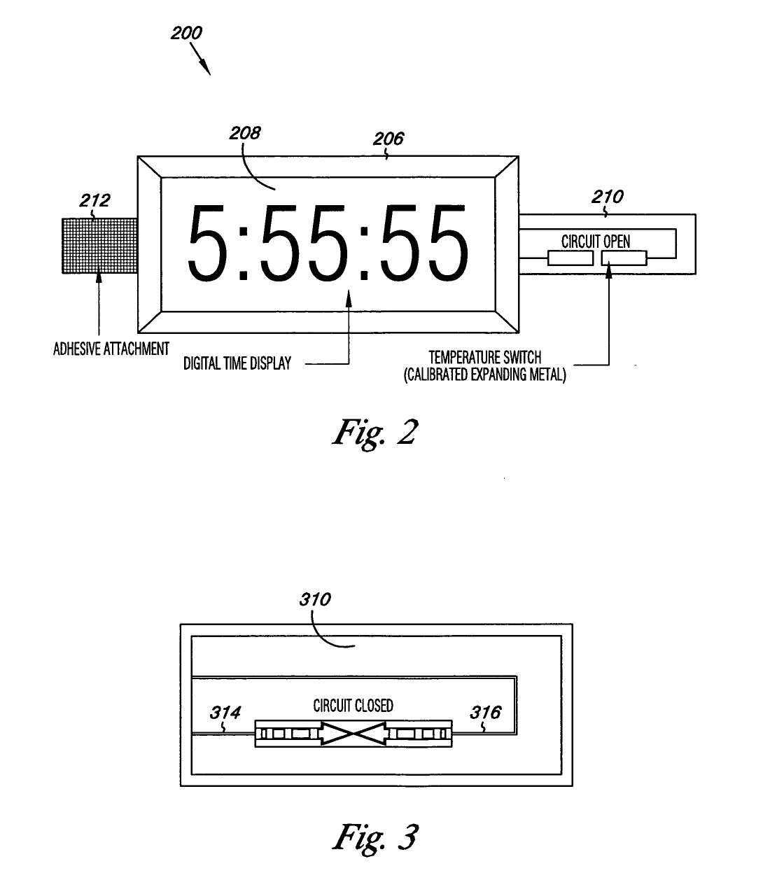

In the embodiment of FIG. 1, a timing apparatus 100 has been positioned on the roll of prepreg material 102. In this embodiment, an adhesive tab has been used to secure the timing apparatus 100 to the core 104 of the roll of prepreg 102. The adhesive tab is shown and discussed in more detail below with respect to FIG. 2.

In this way, the timing apparatus 100 is subjected to similar environmental conditions to that of the item 102. In such embodiments, as discussed above, the triggering mechanism of the timing apparatus 100 can be the same environmental condition that affects the usefulness and/or expiration of the item 102. Additionally, the timing apparatus 100 travels with the item 102, thereby reducing confusion, among other benefits.

FIG. 2 is a close up illustration of an embodiment of a timing apparatus for monitoring item out-time. In this illustration, the timing apparatus 200 includes a body 206 having a display portion 208, a circuit connection portion 210, and an attachment portion 212.

Although, as discussed above, the display portion can utilize a number of different types of indicators, the embodiment illustrated in FIG. 2 utilizes a digital time format display. In such embodiments, the time displayed can be an incremented or decremented time, for example.

In some embodiments, the body 206 can also include one or more mechanisms for setting, resetting, or changing the time on the display. For example, a number of buttons can be provided on the body 206 to change the hours, minutes, and/or seconds displayed, among other functions.

FIG. 2 also illustrates an attachment portion 212. As discussed above, the attachment portion 212 can be in any of various forms (e.g., a tab, the back of the apparatus, etc). In the embodiment shown in FIG. 2, the attachment portion 212 has an adhesive provided thereon for attachment of the timing apparatus 200 to a surface, such as to a surface of an item (e.g., surface 104 of FIG. 1).

FIG. 2 also illustrates circuit connection portion 210. In this embodiment, the circuit connection portion 210 provides the triggering mechanism. In this embodiment, the triggering mechanism is a temperature sensitive material (e.g., a conductive material such as copper) and is illustrated in a circuit open configuration. For example, when used with a refrigerated material, like prepreg, the circuit open configuration would be its refrigerated configuration.

FIG. 3 is an illustration of an embodiment of a triggering mechanism 310 for use with various timing apparatus embodiments. In this embodiment, as with the embodiment of FIG. 2, the triggering mechanism 310 includes a temperature sensitive material and is illustrated in a circuit open configuration.

When the environment changes (e.g., when the apparatus moves from a cold environment to a warmer environment) the temperature sensitive material used in the illustrated embodiment will expand. The expansion will cause the two expanded portions to contact each other, thereby creating an electrical connection.

In the embodiment illustrated in FIG. 3, the electrical connection can be used to provide power to the timer. For example, once the electrical connection is made, electricity will pass between line 314 and line 316. The connection can thereby provide a trigger for the timer and/or logic and can cause the state of the timer to change from a waiting state to an incrementing or decrementing state, for example. In embodiments using logic, a logic state can be changed from a waiting state to a recording, monitoring, and/or calculating state, for example.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of ordinary skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed:

1. A timing apparatus for monitoring item out-time, comprising:
a timer; and
a triggering mechanism for changing the state of the timer based upon an environmental condition.

2. The apparatus of claim 1, wherein the triggering mechanism changes the state of the timer based upon temperature.

3. The apparatus of claim 1, wherein the triggering mechanism is a temperature sensitive material.

4. The apparatus of claim 1, wherein the triggering mechanism includes two pieces of material which form an electrical connection when a change in an environmental condition occurs.

5. The apparatus of claim 1, wherein the triggering mechanism is two pieces of material that forms an electrical connection when a change in temperature occurs.

6. The apparatus of claim 1, wherein the triggering mechanism forms an electrical connection due to the expansion of a piece of material.

7. The apparatus of claim 1, wherein the apparatus further includes an adhesive on at least a portion of the apparatus for adhering the apparatus to a surface.

8. The apparatus of claim 1, wherein the timer includes logic to count from a first predetermined time to a second predetermined time.

9. The apparatus of claim 8, wherein the logic has a number of time thresholds associated therewith.

10. The apparatus of claim 1, wherein the apparatus includes an expired indicator.

11. An out-time apparatus, comprising:
a timer;
a triggering mechanism for changing the state of the timer based upon an environmental condition; and
an adhesive on at least a portion of the apparatus for adhering the apparatus to a surface.

12. The apparatus of claim 11, wherein the apparatus includes logic to record each time the triggering mechanism is triggered.

13. The apparatus of claim 11, wherein the apparatus includes logic to record each time the state of the timer is changed.

14. The apparatus of claim 11, wherein the timer counts down from a preset value and wherein the preset value cannot be reset.

15. The apparatus of claim 11, wherein the timer includes logic and wherein the logic includes a processor.

16. An out-time apparatus, comprising:
means for recording information about the out-time of an item;
means for changing the state of the means for recording based upon an environmental condition.

17. The apparatus of claim 16, wherein the means for recording includes one or more timing components selected from the group including:
a clock;
a decrementing timer; and
an incrementing timer.

18. The apparatus of claim 16, wherein the means for recording includes a logic component and memory.

19. The apparatus of claim 18, wherein the logic component includes a processor.

20. The apparatus of claim 16, wherein the means for changing the state of the means for recording based upon an environmental condition is a logic component.

21. The apparatus of claim 16, wherein the means for changing the state of the means for recording includes a mechanism to close an electrical connection.
